(19) United States
(12) Patent Application Publication
(10) Pub. No.: US 2014/0167936 A1
(43) Pub. Date: Jun. 19, 2014

(54) REMOTE CONTROL APPARATUS AND METHOD USING DYNAMIC SCRIPT

(71) Applicant: ELECTRONICS AND TELECOMMUNICATIONS RESEARCH INSTITUTE, Daejeon-si (KR)

(72) Inventors: Moon-Soo LEE, Daejeon-si (KR); Seung-Joon KWON, Seoul (KR); Min-Jung KIM, Daejeon-si (KR); Sun-Joong KIM, Daejeon-si (KR); Kee-Seong CHO, Daejeon-si (KR)

(21) Appl. No.: 13/933,365

(22) Filed: Jul. 2, 2013

(30) Foreign Application Priority Data
Dec. 14, 2012 (KR) 10-2012-0146416

(51) Int. Cl. G08C 17/00

(52) U.S. Cl. CPC G08C 17/00
USPC 340/12.54; 340/12.22

(57) ABSTRACT

A remote control apparatus and method are provided. A remote control method using a dynamic script in a control terminal includes acquiring a control module written in a dynamic script so as to control a controlled terminal, generating the acquired control module as a dynamic script character string, executing the generated dynamic script, performing connection with the controlled terminal through the executed control module, visualizing a GUI for remote control which is included in the executed control module and outputting the visualized GUI on the screen, and transmitting, when GUI-based event information is received from a user, the event information to the controlled terminal.

### CROSS-REFERENCE TO RELATED APPLICATION

This application claims the benefit under 35 U.S.C. §119(a) of a Korean Patent Application No. 10-2012-0146416, filed on Dec. 14, 2012, the entire disclosure of which is incorporated herein by reference for all purposes.

### BACKGROUND

1. Field

The following description relates to a remote control apparatus and method, and more particularly, to an apparatus and method for controlling a controlled terminal which is located at a remote position using a user's terminal.

2. Description of the Related Art

Due to the recent development of mobile devices and expansion of the market thereof, the number of devices owned or accessible by individuals is gradually increasing. As a result, there are demands for consuming content on a screen optimized for each piece of the content among the devices owned by individuals. As the current technology that meets the demands, service providers or content providers offer N-screen services or digital signage services.

The N-screen services may enable content consumed by users to be continuously shared in a variety of terminals through movement between terminals. However, in the N-screen, content whose operation or control is simply performed in units of files such as images, music, moving pictures, and the like is mainly used. In order to provide corresponding content, a separate server such as a cloud server has to be built and then continuously maintained and managed, resulting in an increase in costs.

As a representative technology of the N-screen services which can be simply used in a home without requiring the costs for the server, a digital living network alliance (DLNA) is used. In the DLNA, there is no need to build a separate server in order to share or remotely control content between terminals unlike the cloud or server-based N screen services, but multi-media services between terminals may be shared using peer-to-peer (P2P) communication.

Accordingly, the DLNA may be more effective in terms of maintenance costs for a variety of content compared to the server-based N screen services, but a software stack for supporting a DLNA function in a terminal has to be installed in advance.

In addition, in accordance with diversification of kinds of content which are supported, a communication protocol between a client and a server should be defined so as to be added in the software stack or should be developed and then continuously updated.

### SUMMARY

The following description relates to an apparatus and method for controlling a controlled terminal located in a remote position by a control terminal using a control module created using a dynamic script without a separate server device.

In one general aspect, a controlled terminal includes: a control module providing unit that generates a control module for remotely controlling the controlled terminal using a dynamic script and provides the generated control module to a control terminal; and an event interpretation unit that receives a user event from the control terminal after connection with the control terminal that has received the control module is performed, and controls an inner operation in accordance with a result obtained by interpreting the received user event.

In another general aspect, a control terminal includes: a control module acquisition unit that acquires a control module for remotely controlling a controlled terminal to generate the acquired control module as a dynamic script character string; a script execution engine that executes the dynamic script generated by the control module acquisition unit; a control interface processing unit that visualizes a graphic user interface (GUI) for remote control which is included in the control module executed by the script execution engine and outputs the visualized GUI on a screen; and an event transmission unit that transmits, when GUI-based event information is received from a user, the event information to the controlled terminal.

In still another general aspect, a remote control method using a dynamic script in a controlled terminal includes: generating a control module for remotely controlling the controlled terminal using the dynamic script; providing the generated control module to a control terminal; performing connection with the control terminal that has received the control module; receiving a user event from the control terminal; interpreting the received user event; and controlling an inner operation in accordance with a result obtained by interpreting the user event.

In yet another general aspect, a remote control method using a dynamic script in a control terminal includes: acquiring a control module written in a dynamic script so as to control a controlled terminal; generating the acquired control module as a dynamic script character string; executing the generated dynamic script; performing connection with the controlled terminal through the executed control module; visualizing a GUI for remote control which is included in the executed control module and outputting the visualized GUI on the screen; and transmitting, when GUI-based event information is received from a user, the event information to the controlled terminal.

Other features and aspects will be apparent from the following detailed description, the drawings, and the claims.

### BRIEF DESCRIPTION OF THE DRAWINGS

FIG. 1 is a diagram illustrating a schematic configuration for remote control between terminals according to an embodiment of the present invention;

FIG. 2 is a diagram illustrating a detailed configuration of a controlled terminal and a control terminal which perform remote control according to an embodiment of the present invention;

FIG. 3 is a diagram illustrating an example of a control module in the form of an HTML document according to an embodiment of the present invention;

FIG. 4 is a diagram illustrating an example of transmission and reception of a control module according to an embodiment of the present invention;

FIG. 5 is a diagram illustrating another example of transmission and reception of a control module according to an embodiment of the present invention; and

FIG. 6 is a flowchart illustrating a remote control method using a dynamic script according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

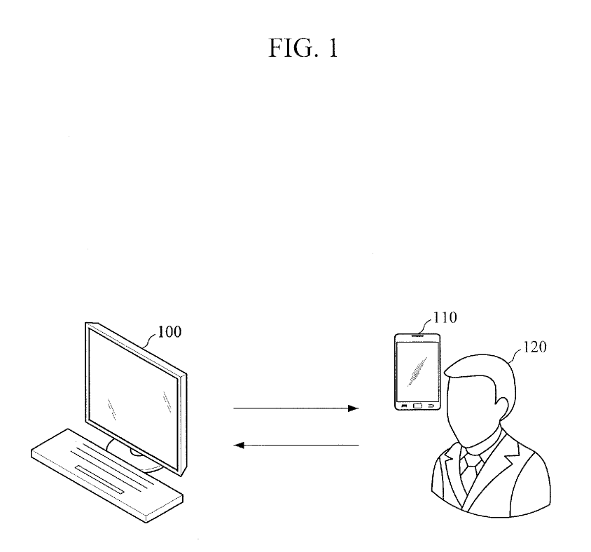

FIG. 1 is a diagram illustrating a schematic configuration for remote control between terminals according to an embodiment of the present invention.

Referring to FIG. 1, according to an embodiment of the present invention, a controlled terminal 100 and a control terminal 110 are provided. Each of the terminals 100 and 110 may include an operating function for interpreting and executing a dynamic script such as a desktop, a laptop, a smart phone, a mobile terminal, and the like and a wired/wireless IP network connection function for connecting networks. In addition, each of the terminals 100 and 110 may include an input interface for inputting information in the terminals 100 and 110 by a user 120 including a touch screen, a mouse, a microphone, a camera, and the like, and an output interface for outputting information so that the information can be recognized by a user 12 including a monitor, a projector, a head-mounted display, a head-up display, a speaker, and the like. This input interface and output interface are a basic configuration of each of the terminals 100 and 110, and thus description thereof will be omitted.

The controlled terminal 100 stores a control module that is defined by a dynamic script so as to control content or applications in the terminal. The control terminal 110 acquires the control module, visualizes a remote control graphic user interface (GUI) to the user 120, and then outputs the visualized GUI on a screen. When a GUI-based command is input by the user 120, the control terminal 110 transmits the input command as control information to the controlled terminal 100 located at a remote position.

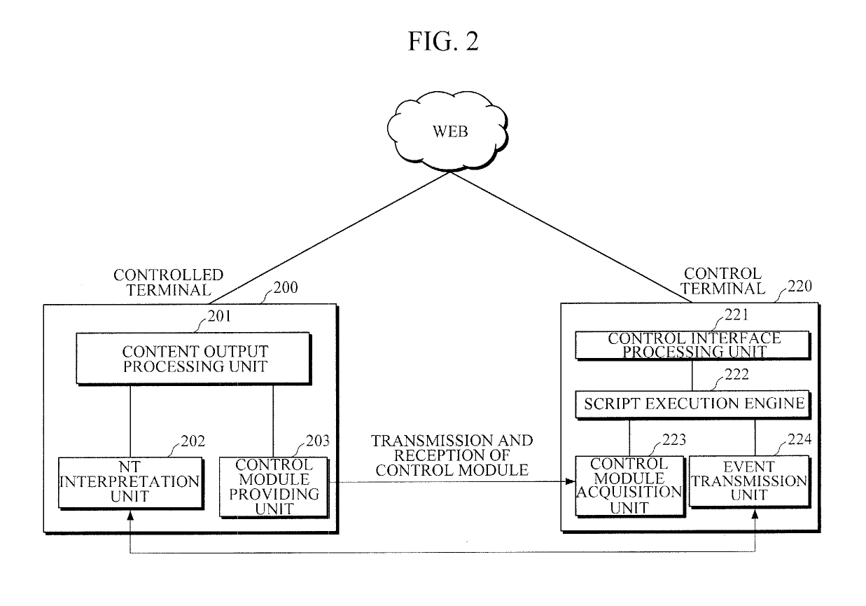

FIG. 2 is a diagram illustrating a detailed configuration of a controlled terminal and a control terminal which perform remote control according to an embodiment of the present invention.

Referring to FIG. 2, a controlled terminal 200 for providing a control module or receiving a remote control signal and a control terminal 220 for remotely controlling the controlled terminal 200 in accordance with control information received from the user 120 are provided.

When the control module is transmitted and received between the controlled terminal 200 and the control terminal 220, the above-described remote control is made possible.

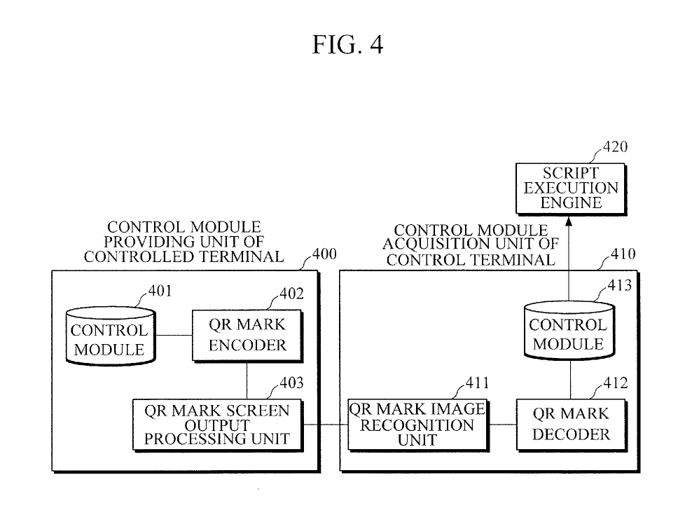

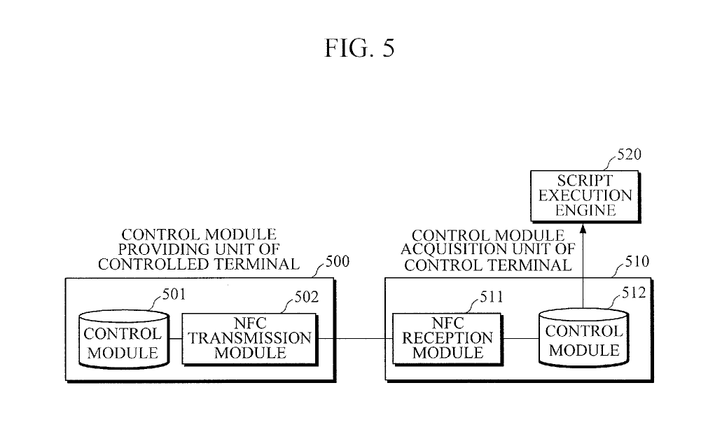

There are a variety of methods for transmitting and receiving the control module. As an example, a method for recognizing text through images such as a QR code, character recognition, and the like may be used. This will be described later with reference to FIG. 4. As another example, a peer-to-peer (P2P) communicable wireless transmission method such as an IR sensor, a near field communication (NFC) sensor, direct Wi-Fi, Bluetooth, and the like may be used. This will be described in detail later with reference to FIG. 5.

The controlled terminal 200 includes a content output processing unit 201, an event interpretation unit 202, and a control module providing unit 203.

The content output processing unit 201 is a device for displaying controlled content on a screen in the controlled terminal 201, and as the content, a variety of inner services such as text, images, moving pictures, window panels, applications, and the like may be given.

The control module providing unit 203 transmits the control module to the control terminal 220, and there are a variety of transmission methods. As an example, a method of recognizing text through images such as a QR code, character recognition, and the like may be used. This will be described later with reference to FIG. 4. As another example, a P2P communicable wireless transmission method such as an IR sensor, an NFC sensor, direct Wi-Fi, Bluetooth, and the like may be used. This will be described in detail later with reference to FIG. 5.

The event interpretation unit 202 receives user event information from the control terminal 220 after connection between terminals is performed by the control module, and controls services provided from the controlled terminal 200 in accordance with a result obtained by interpreting the received user event information.

The control terminal 220 includes a control interface processing unit 221, a script execution engine 222, a control module acquisition unit 223, and an event transmission unit 224.

The control module acquisition unit 223 acquires the control module from the controlled terminal 200, and generates the acquired control module as a dynamic script character string. Here, the method of acquiring the control module may have a variety of examples. As an example, a method of recognizing text through images such as a QR code, character recognition, and the like may be used. This will be described later with reference to FIG. 4. As another example, a P2P communicable wireless transmission method such as an IR sensor, an NFC sensor, direct Wi-Fi, Bluetooth, and the like may be used. This will be described in detail later with reference to FIG. 5.

The script execution engine 222 interprets and executes the dynamic script generated by the control module acquisition unit 223. The dynamic script is a character string in the form of text including HTML, Java Script, Python, Perl, and the like independent of an operating system (OS) of the terminal, and refers to a dynamically executable program module. The script execution engine 222 may be an execution application in the form of stand-alone or a script engine mounted in a web browser or a web OS.

The control interface processing unit 221 visualizes a viewer portion of GUI such as a virtual keyboard, a menu, and the like included in the control module 230 and outputs the visualized portion on the screen.

The event transmission unit 224 transmits corresponding event information to the controlled terminal 200 when GUI-based user event information displayed by the control interface processing unit 221 is input.

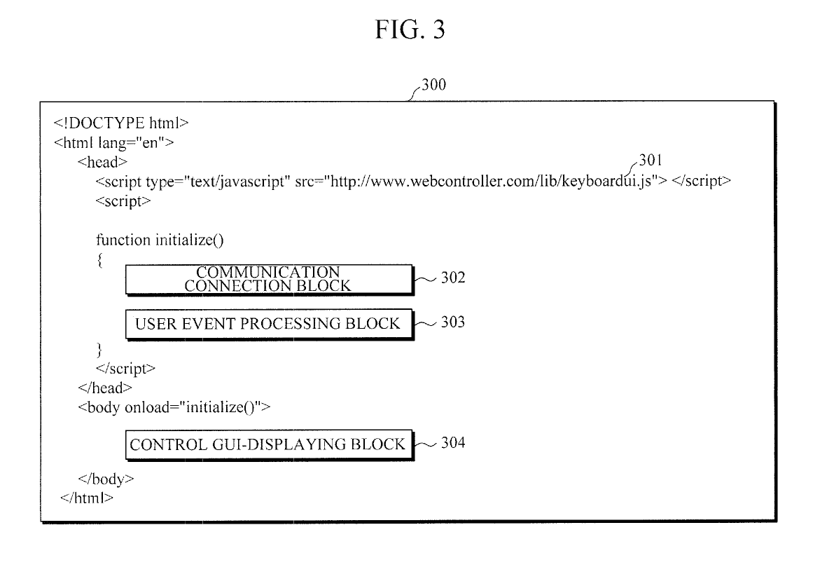

FIG. 3 is a diagram illustrating an example of a control module in the form of an HTML document according to an embodiment of the present invention.

However, the control module is not limited to the HTML document, and may be written in a variety of forms such as pure Java Script, Python, Perl, a user-defined script, and the like.

Referring to FIG. 3, a control module 300 includes a web resource reference block 301, a communication connection block 302, a user event processing block 303, and a control GUI-displaying block 304.

The web resource reference block 301 may define a library for downloading, to the control terminal 110, a large amount of logic or a commonly used library through a web.

Since there are many cases in which the control module 300 cannot include a colorful graphic UI or images due to its small capacity, in the case of the library that is commonly and frequently used, resources in the web rather than the controlled terminal 100 may be downloaded.

The communication connection block 302 is a code block that is connected with the controlled terminal 100. As a method of being connected with the controlled terminal 100, a variety of IP-based wired/wireless network connections including a socket, a web socket, a remote procedure call, and the like may be used.

Main logic of the communication connection block 302 may write, in a script, a connection method with information required for connection such as an IP, a port, a user ID, and the like of the controlled terminal 200 desired to be connected.

The user event processing block 303 transmits a corresponding command event to the controlled terminal 200 through the communication connection block 302 when a user input event is input by a user through the input interface including a touch screen, a keyboard, a mouse, an electronic pen, and the like.

The control GUI-displaying block 304 outputs a control GUI for controlling the controlled terminal 200. For example, in the control GUI-displaying block 304, a menu, an option, or an input box for controlling the controlled terminal 200 may be included.

FIG. 4 is a diagram illustrating an example of transmission and reception of a control module according to an embodiment of the present invention.

Referring to FIG. 4, a control module providing unit 400 of the controlled terminal may include a control module 401, a QR code encoder 402, and a QR code screen output processing unit 403.

The QR code may be generated in real-time through the output interface such as a monitor, a projector, an HUD, an HMD, a transparent display, and the like, and may be generated offline such as a sticker, printing, or the like. Here, an example of generating the QR code in real-time will be described.

In the control module 401, encoding is performed by the QR code encoder 402 so that a QR code in the form of an image may be generated. The generated QR code may be output to a display such as a monitor, a projector, or the like through the QR code screen output processing unit 403.

The control module acquisition unit 410 of the control terminal includes a QR code image recognition unit 411, a QR code decoder 412, and a control module 413.

The QR code image recognition unit 411 extracts a QR code portion of an image captured by a camera. The extracted QR code may be restored to an original control module 413 in the form of text through the QR code decoder 412. The restored control module 413 is transmitted to the script execution engine 420 to be executed.

FIG. 5 is a diagram illustrating another example of transmission and reception of a control module according to an embodiment of the present invention.

Referring to FIG. 5, a short-range wireless communication means may include all network devices that support a P2P communication method to NFC, direct Wi-Fi, Bluetooth, UPnP, or the like, and in FIG. 5, an example of NFC will be described.

A control module providing unit 500 of the controlled terminal and a control module acquisition unit 510 of the control terminal are in a mutually communicable state through NFC pairing, and transmit a control module 501 through an NFC transmission module 502. An NFC reception module 511 transmits the received control module 512 to a script execution engine 520 to execute the transmitted control module 512.

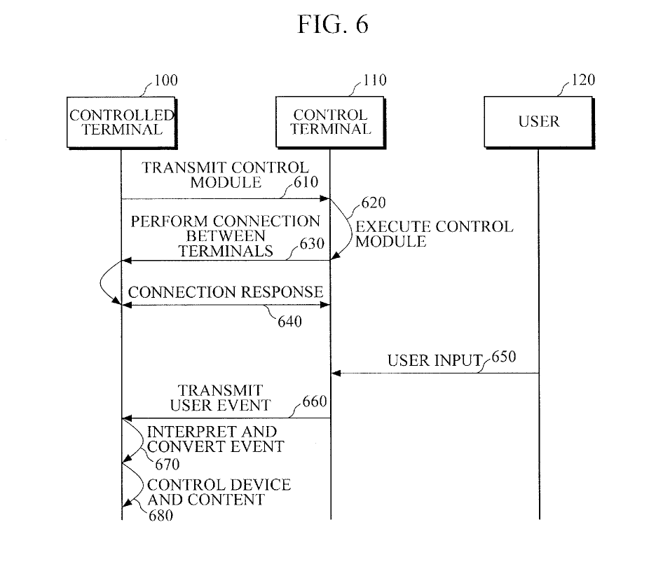

FIG. 6 is a flowchart illustrating a remote control method using a dynamic script according to an embodiment of the present invention.

Referring to FIG. 6, in step 610, the controlled terminal 100 transmits a control module written in a dynamic script to the control terminal 110. There are a variety of methods for transmitting the control module. As an example, as illustrated in FIG. 4, a method for recognizing text through images such as a QR code, character recognition, and the like may be used. As another example, as shown in FIG. 5, a P2P communicable wireless transmission method such as an IR sensor, an NFC sensor, direct Wi-Fi, Bluetooth, and the like may be used.

In step 620, the control terminal 110 executes the received control module. More specifically, the received control module may be generated as a dynamic script character string, and a GUI for remote control may be displayed on a user screen by executing the control GUI-displaying block 304 of the control module.

In step 630, the control terminal 110 is connected to the controlled terminal 100. The script execution engine of the control terminal 110 interprets the communication connection block 302 of the control module, and performs connection using a wired/wireless network with the controlled terminal 100.

In step 640, the controlled terminal 100 transmits a connection response so that the controlled terminal 100 and the control terminal 110 are connected with each other.

In step 650, a user 120 inputs user event information through the GUI for remote control which is displayed on a screen of the control terminal 110.

Next, in step 660, the control terminal 110 transmits the input user event information to the controlled terminal 100.

In step 670, the controlled terminal 100 interprets the received event information and converts the interpreted event information so as to be suitable for the controlled terminal 100.

Next, in step 680, the controlled terminal 100 controls an inner device or currently used content in accordance with the interpreted event information.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A controlled terminal comprising:
a control module providing unit that generates a control module for remotely controlling the controlled terminal using a dynamic script and provides the generated control module to a control terminal; and
an event interpretation unit that receives a user event from the control terminal after connection with the control terminal that has received the control module is performed, and controls an inner operation in accordance with a result obtained by interpreting the received user event.

2. The controlled terminal according to claim 1, further comprising:
a content output processing unit that outputs content in accordance with services on a screen or by voice through the control of the event interpretation unit.

3. The controlled terminal according to claim 2, wherein the content includes at least one of text, images, moving pictures, window panels, and applications.

4. The controlled terminal according to claim 1, wherein the control module providing unit transmits the control module using one of peer-to-peer wireless transmission methods including an infrared sensor, a near field communication (NFC) sensor, Wi-Fi, and Bluetooth.

5. The controlled terminal according to claim 1, wherein the control module providing unit generates the control module as an image including a QR code or characters, and outputs the generated control module on a screen.

6. A control terminal comprising:
a control module acquisition unit that acquires a control module for remotely controlling a controlled terminal to generate the acquired control module as a dynamic script character string;
a script execution engine that executes the dynamic script generated by the control module acquisition unit;
a control interface processing unit that visualizes a graphic user interface (GUI) for remote control which is included in the control module executed by the script execution engine and outputs the visualized GUI on a screen; and
an event transmission unit that transmits, when GUI-based event information is received from a user, the event information to the controlled terminal.

7. The control terminal according to claim 6, wherein the dynamic script is a dynamically executable program module as one of character strings in the form of text including HTML, Java Script, Python, and Perl.

8. The control terminal according to claim 6, wherein the script execution engine is one of an execution application in the form of stand-alone and script engines mounted in a web browser or a web operating system.

9. The control terminal according to claim 6, wherein the control module acquisition unit extracts a QR code portion of an image captured through a camera, and restores the extracted QR code to the control module in the form of text.

10. The control terminal according to claim 6, wherein the control module providing unit acquires the control module using one of peer-to-peer wireless transmission methods including an infrared sensor, an NFC sensor, Wi-Fi, and Bluetooth.

11. The control terminal according to claim 6, wherein the control module includes
a web resource reference block that defines a library for downloading a large amount of logic or libraries from a web,
a communication connection block in which connection information including an IP, a port, and a user ID of the controlled terminal desired to be connected and a connection method are written in a script, and
a user event processing block that transmits, when a GUI-based user input event for remote control is generated by a user, a corresponding command event to the controlled terminal through the communication connection block.

12. A remote control method using a dynamic script in a controlled terminal, comprising:
generating a control module for remotely controlling the controlled terminal using the dynamic script;
providing the generated control module to a control terminal;
performing connection with the control terminal that has received the control module;
receiving a user event from the control terminal;
interpreting the received user event; and
controlling an inner operation in accordance with a result obtained by interpreting the user event.

13. The remote control method according to claim 11, wherein the generating includes generating a QR code in the form of an image by performing encoding of the control module, and the providing includes outputting the QR code in the form of the image on a screen.

14. A remote control method using a dynamic script in a control terminal, comprising:
acquiring a control module written in a dynamic script so as to control a controlled terminal;
generating the acquired control module as a dynamic script character string;
executing the generated dynamic script;
performing connection with the controlled terminal through the executed control module;
visualizing a GUI for remote control which is included in the executed control module and outputting the visualized GUI on the screen; and
transmitting, when GUI-based event information is received from a user, the event information to the controlled terminal.

15. The remote control method according to claim 14, wherein the acquiring includes
extracting a QR code of an image captured through a camera, and
restoring the extracted QR code to the control module in the form of text.
